(19) United States
(12) Patent Application Publication
(10) Pub. No.: US 2006/0159855 A1
(43) Pub. Date: Jul. 20, 2006

(54) Blade coating method and disk coating method using the same

(75) Inventors: Shinsuke Takahashi, Kanagawa (JP); Takayoshi Ose, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/330,103

(22) Filed: Jan. 12, 2006

(30) Foreign Application Priority Data
Jan. 18, 2005 (JP) P.2005-010531

(51) Int. Cl. B05D 3/12; B05D 1/32; B05D 5/12

(52) U.S. Cl. 427/355; 427/282; 427/127

(57) ABSTRACT

A blade coating method comprising: laying a mask on top of a flat substrate, the mask having an opening; supplying a coating liquid onto the mask; applying the coating liquid onto the mask by use of a blade moving above the mask and relatively to the mask; and separating the mask and the flat substrate from each other, so as to form a coating liquid layer on the flat substrate in accordance with the opening of the mask; wherein: a relative movement speed between the mask and the flat substrate when the mask and the flat substrate are operated to leave each other is set to be in a range of from 50 mm/sec to 200 mm/sec.

### FIELD OF THE INVENTION

The present invention relates to a blade coating method for applying a coating liquid on to a flat substrate by use of a blade, and a disk coating method using the blade coating method.

### BACKGROUND OF THE INVENTION

Various proposals have been heretofore made for stably applying a liquid coating material onto a to-be-coated surface of a to-be-coated member. For example, a coating apparatus disclosed in JP-A-63-224761 includes side frames sliding on a to-be-coated member, and two blades provided to extend between the side frames so as to form a pocket for storing a coating liquid. The coating apparatus drains and applies the coating liquid from the pocket onto the to-be-coated member through a gap which is located in a lower end of one of the blades on the downstream in a movement direction. The coating apparatus has a lubrication layer forming means for forming a lubrication layer on an upper surface of the to-be-coated member on which the side frames slide. With this configuration, the surface smoothness of lower surfaces of the side frames is improved so that continuous banding in the extension direction of the blades can be prevented from occurring in the to-be-coated surface.

A substrate coating apparatus disclosed in JP-A-9-10646 includes a micro rod bar having its lower portion soaked in a coating liquid tank, and a nip roller disposed above the micro rod bar and oppositely thereto. A substrate is fed while being nipped between the micro rod bar and the nip roller. Thus, a lower surface of the substrate is coated with a coating liquid. In the substrate coating apparatus, a thrust member is provided on a substrate entry side of the micro rod bar. The thrust member serves to support a front edge of the substrate from below so as to restrict bending of the front edge of the substrate. With this configuration, coating near the center of the front edge of the substrate can be prevented from being thicker than that on either side thereof. Thus, coating with a uniform thickness can be attained. Moreover, the vicinity of the center of a rear edge of the substrate can be prevented from abutting against an exit-side gate of the coating liquid tank. Thus, coating with a uniform thickness can be attained.

Further, a roll coater disclosed in JP-A-10-128221 includes a conveyance stage for conveying a sheet to be coated and a coating roll. The conveyance stage is moved to pass under the coating roll so that a solution is applied onto a surface of the sheet. In the conveyance stage, a retention plate for retaining the sheet is disposed on an upper surface of a base with a gap therebetween, while elastic members are disposed in a surface-direction intermediate portion of the gap axi-symmetrically with respect to a line segment passing through the center of the sheet in the movement direction of the conveyance stage. In addition, a circumferential edge portion of the retention plate is restricted by gap restricting means so that the gap can be adjusted. With this configuration, when the retention plate passes through the coating roll while pressing the coating roll, the retention plate tilts within the range of the gap so as to control the reaction force (elastic force) of the elastic members. Thus, the shock which may occur due to the contact entry of the retention plate can be relaxed. In this manner, unevenness in coating can be prevented from being caused by the shock vibration.

A disk coating apparatus shown in FIGS. 6A and 6B is a background-art disk coating apparatus 1 for applying a coating liquid with a thickness of about 100 μm onto a disk-like recording medium such as an optical disk so as to form a printable coating liquid layer (ink accepting layer) 9 thereon. The disk coating apparatus 1 has a suction stage 2, an air cylinder 3, a mask plate (mask) 4 and a blade 5. The suction stage 2 serves to suck and mount an optical disk D thereon. The air cylinder 3 serves to move up and down the optical disk D together with the suction stage 2. The mask plate 4 has an opening 8 defined by a circular edge portion 4a. The blade 5 is driven to move horizontally above the mask plate 4 while keeping a predetermined gap with the mask plate 4. Thus, a coating liquid 6 is applied onto the optical disk D to thereby form a coating liquid layer 9 thereon.

The coating liquid 6 is applied by the disk coating apparatus 1 as follows. After an optical disk D is fixedly mounted and sucked on the suction stage 2, the air cylinder 3 is operated to move up the optical disk D so that the mask plate 4 is laid on top of the optical disk D, as shown in FIG. 6A. The blade 5 is moved above the mask plate 4 and relatively to the mask plate 4 in the direction of an arrow A while the coating liquid 6 is supplied onto the mask plate 4. Thus, the coating liquid 6 is applied to a to-be-coated surface 7 of the optical disk D exposed from the opening 8 of the mask plate 4. Then, as shown in FIG. 6B, the air cylinder 3 is operated to move down the suction stage 2 (in the direction of an arrow B) so as to separate the optical disk D from the mask plate 4. Thus, a coating liquid layer 9 is formed on the optical disk D in accordance with the opening 8 of the mask plate 4.

### SUMMARY OF THE INVENTION

The coating apparatus disclosed in JP-A-63-224761 can be indeed configured in a simple structure. However, an applicator partially supported on the to-be-coated member performs application while keeping a relative distance between the downstream-side blade and the to-be-coated member. As a result, there is a defect that the to-be-coated member is limited to a belt-like member such that uncoated portions may be generated on the opposite end sides of the blades.

The substrate coating apparatus disclosed in JP-A-9-10646 can perform coating in the full width because the nipped substrate is coated by the micro rod bar from below. However, the to-be-coated member is limited to a belt-like member or a rectangular member. When the liquid film becomes thick, there arises a problem that stripes may occur in the coated surface due to disorder of beads on the downstream side of the micro rod bar.

The roll coater disclosed in JP-A-10-128221 can coat each to-be-coated member which will be shaped like a disk, and also can coat the whole surface of the to-be-coated member. However, each to-be-coated member must be supported by the elastic members. Accordingly, the equipment becomes so massive. In addition, when the liquid film becomes thick, there also arises a problem that stripes may occur in the same manner as in the aforementioned substrate coating apparatus.

In brief, the background art has the following defects. That is, the apparatus becomes massive. Particularly when the coating thickness increases, the quantity of the coating liquid pushed into the gap between each blade and the to-be-coated surface increases. Due to distortion of the blade brought about thus, there may appear stripes approximately parallel in the coating direction, or disorder of the liquid interface immediately after the passage of the blade becomes so conspicuous that stripes approximately parallel in the coating direction may occur in the same manner as described above. As a result, it is difficult to ensure a good coating film surface.

When the coating liquid 6 is applied to the to-be-coated surface 7 of the optical disk D by the background-art disk coating apparatus 1 shown in FIGS. 6A and 6B, the coating liquid 6 is applied continuously from an upper surface of the mask plate 4 to the to-be-coated surface 7 of the optical disk D exposed from the opening 8, as shown in FIG. 7A. When the suction stage 2 is moved down to separate the optical disk D from the mask plate 4, the coating liquid 6 having viscosity is expanded vertically in the circular edge portion 4a of the opening 8 (FIG. 7B) so that a substantially cylindrical liquid film 6A is formed between the mask plate 4 and the optical disk D (FIG. 7C). When the optical disk D is further moved down, the liquid film 6A is soon broken so that the coating liquid 6 flies around as flying drops 6B as shown in FIG. 7D. The flying drops 6B adhere to the coating liquid layer (ink accepting layer) 9 applied to the to-be-coated surface 7 of the optical disk D. Thus, there is a problem that the surface property of the coating liquid layer 9 is degraded to lead to trouble in subsequent printing etc.

The invention was achieved under such circumstances. An object of the invention is to provide a blade coating method having a simple apparatus configuration in which flying drops of a coating liquid can be prevented from being generated when an optical disk is separated from a mask plate, so that the coating liquid can be applied stably, and a disk coating method using the blade coating method, so that application of the coating liquid can be performed with a good surface property.

The object of the invention will be attained by the following configurations.

(1) A blade coating method including the steps of: laying a mask on top of a flat substrate, the mask having an opening; supplying a coating liquid onto the mask; applying the coating liquid onto the mask by use of a blade moving above the mask and relatively to the mask; and separating the mask and the flat substrate from each other, so as to form a coating liquid layer on the flat substrate in accordance with the opening of the mask; wherein a relative movement speed between the mask and the flat substrate when the mask and the flat substrate are operated to leave each other is set to be in a range of from 50 mm/sec to 200 mm/sec.

According to the blade coating method, the relative movement speed between the mask and the flat substrate when the mask and the flat substrate are operated to leave each other is set to be in the range of from 50 mm/sec to 200 mm/sec. Accordingly, it is possible to restrain a liquid film from being generated between the mask and the flat substrate. Therefore, the liquid film which may grow with the separation operation and generate flying drops when the liquid film is naturally broken, can be prevented from adhering to the flat substrate. Thus, a coating liquid layer with a good surface property can be formed.

(2) A disk coating method including the step of forming at least one layer of a printing surface of a disk-like recording medium by use of a blade coating method according to the paragraph (1).

In this disk coating method, a coating apparatus capable of coating in a large area is used to form at least one layer of a printing surface of a disk-like recording medium. Accordingly, it is possible to form a uniform and high-quality coating liquid layer. Thus, the printing layer (ink accepting layer) on which printing will be performed, for example, by an inkjet printer can be formed to be thick enough to provide necessary and sufficient ink acceptability.

In the blade coating method and the disk coating method using the blade coating method according to the invention, a liquid film which may be generated between a mask and a flat substrate can be restrained from growing up when the mask and the flat substrate are separated from each other. Accordingly, flying drops which may be generated when the liquid film growing up is naturally broken can be prevented from adhering to the flat substrate. Thus, a uniform and high-quality coating liquid layer can be formed in a printing surface of a disk-like recording medium.

### BRIEF DESCRIPTION OF THE DRAWINGS

FIG. 1 is a schematic view showing the fundamental configuration of a coating apparatus according to the invention.

FIG. 2 is a schematic perspective view showing the external appearance of the coating apparatus depicted in FIG. 1.

FIGS. 3A-3C are explanatory views showing the fundamental procedure of a coating method according to the invention.

FIGS. 4D-4G are explanatory views showing the fundamental procedure of the coating method according to the invention.

FIG. 5 is a plan view of a to-be-coated member which has been completely coated.

FIGS. 6A and 6B show states where a coating liquid is applied by a background-art disk coating apparatus, FIG. 6A being a perspective view showing the state in which the coating liquid has been applied onto an optical disk by a blade, FIG. 6B being a perspective view showing the state in which the optical disk has been separated from a mask plate.

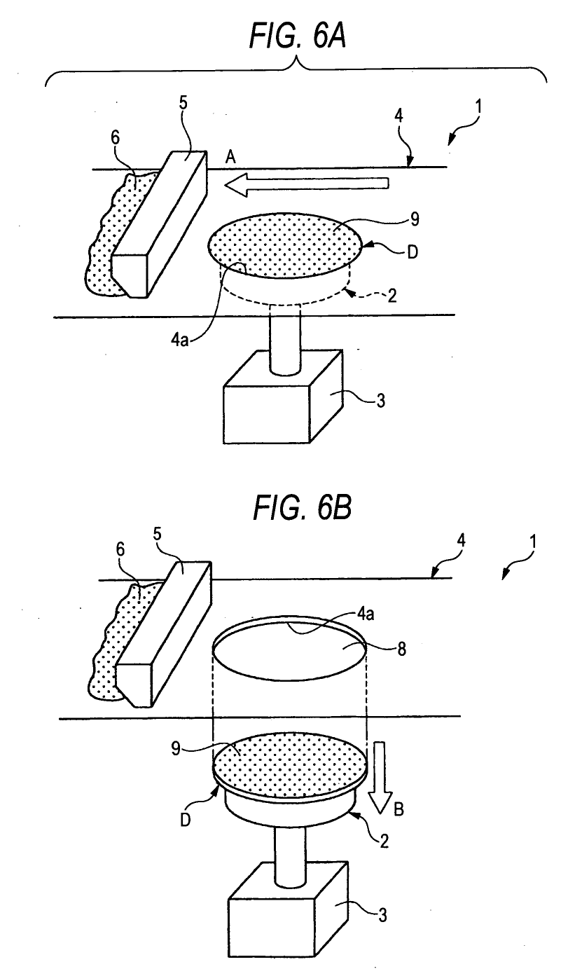

FIGS. 7A to 7D are explanatory views showing respective states in a process where an optical disk leaves a mask plate by means of a background-art disk coating apparatus.

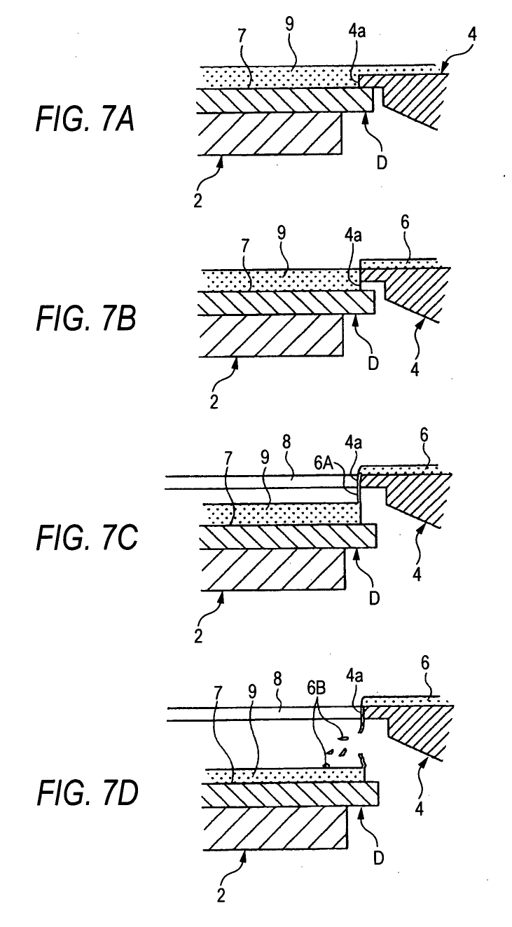

### DESCRIPTION OF REFERENCE NUMERALS

25 mask plate (mask)
27 opening
49 coating liquid (coating liquid layer)
51 blade
63 control portion
100 blade coating apparatus
D optical disk (disk-like recording medium, flat substrate)
V relative movement speed

### DETAILED DESCRIPTION OF THE INVENTION

A blade coating apparatus preferred for achievement of a blade coating method and a disk coating method using the blade coating method according to the invention will be described below in detail with reference to the drawings.

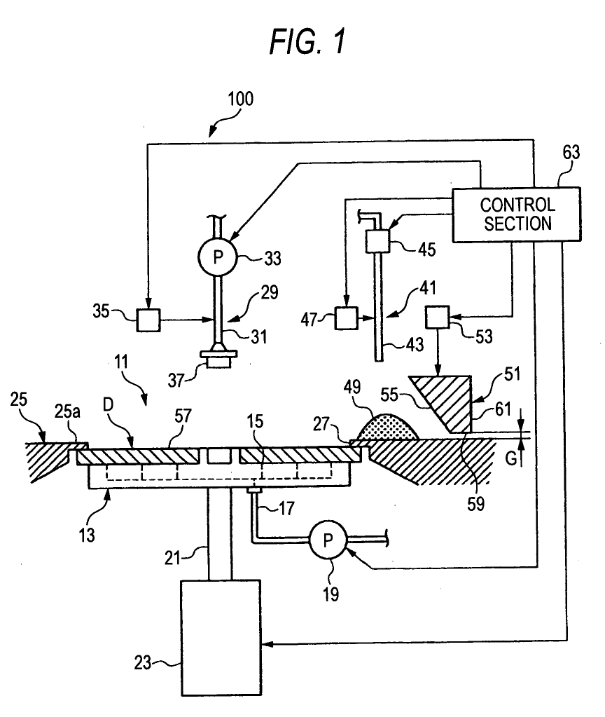

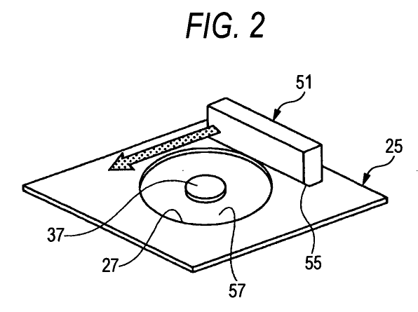

FIG. 1 is a schematic view showing the configuration of a coating apparatus according to the invention. FIG. 2 is a schematic perspective view showing the external appearance of the coating apparatus depicted in FIG. 1.

The blade coating apparatus 100 according to the embodiment is used for applying a liquid film on a to-be-coated member represented by a disk-like recording medium such as an optical disk D which is an example of a flat substrate.

First, the configuration of the blade coating apparatus 100 will be described.

As shown in FIG. 1, a circular suction stage 13 is provided in a coating portion 11 of the blade coating apparatus 100 so that the optical disk D can be sucked and mounted on the suction stage 13. A plurality of suction holes 15 are opened in an upper surface of the suction stage 13. A vacuum pump 19 is connected to the suction holes 15 through a suction channel 17. When the vacuum pump 19 is operated, the suction stage 13 can suck and retain the optical disk D on the upper surface of the suction stage 13 through the suction holes 15.

The suction stage 13 is vertically movably supported by an elevating shaft 21 at the center of the lower surface thereof. The elevating shaft 21 is driven by an air cylinder 23 so as to move up/down. The air cylinder 23 is an example of a mask separating unit.

A mask plate (mask) 25 is provided above the suction stage 13. The mask plate 25 has an opening 27 for exposing a to-be-coated surface 57 of the optical disk D. When the elevating shaft 21 is driven by the air cylinder 23, the elevating shaft 21 moves up. As soon as the elevating shaft 21 reaches an upper limit position, an outer circumferential edge of the optical disk D mounted on the suction stage 13 is covered with an opening circumferential edge 25a of the mask plate 25.

The coating portion 11 is provided with a mask cap sucking/releasing unit 29 above a central portion of the optical disk D. The mask cap sucking/releasing unit 29 includes a cap suction nozzle 31, a vacuum pump 33 and an elevating unit 35. When the vacuum pump 33 is driven, the mask cap sucking/releasing unit 29 sucks and retains a mask cap 37 in a lower end of the cap suction nozzle 31. When the elevating unit 35 is driven in this condition, the cap suction nozzle 31 is moved down so that the mask cap 37 is inserted into a hole in the central portion of the optical disk D. The mask cap (center cap) is not limited to this configuration. The mask cap may be sucked/released by any other mechanical means. For example, there is a method in which the mask cap 37 thrust from below to thereby rise from the mask plate 25 is scooped out from side.

A coating liquid supply unit 41 is provided above the mask plate 25 and outside the opening 27. The coating liquid supply unit 41 includes a coating liquid supply nozzle 43, a coating liquid supply device 45 and a nozzle elevating device 47. By the coating liquid supply unit 41, a coating liquid 49 supplied from the coating liquid supply device 45 is dropped and supplied onto the mask plate 25 through the coating liquid supply nozzle 43. On this occasion, the coating liquid supply nozzle 43 is moved to a height close to the mask plate 25 by the nozzle elevating device 47 only when the coating liquid supply nozzle 43 needs to drop and supply the coating liquid 49. Ordinarily, the coating liquid supply nozzle 43 is moved up to a position where the coating liquid supply nozzle 43 will not be an obstacle to a coating process. Thus, the coating liquid supply nozzle 43 is made to stand by.

Here, for example, a coating liquid with a viscosity at 25° C. of 150 cP to 800 cP can be used as the coating liquid 49. Particularly, the coating liquid 49 with a viscosity at 25° C. of 200 cP to 600 cP is preferably used.

A blade 51 is disposed to stand by further outside the coating liquid 49 supplied onto the mask plate 25 by the coating liquid supply unit 41. When the blade 51 is driven by a moving unit 53 so as to move horizontally above the mask plate 25 while keeping a predetermined gap with the mask plate 25, the blade 51 moves while pushing the coating liquid 49 with its front side surface 55. Thus, the coating liquid 49 is applied onto a to-be-coated surface 57 of the optical disk D exposed by the opening 27 of the mask plate 25 as shown in FIG. 2.

The blade 51 is made of a metal material such as a stainless steel material formed to be long in a direction perpendicular to the paper surface of FIG. 1. The blade 51 is formed into a substantially trapezoidal shape in section perpendicular to the longitudinal direction of the blade 51. In addition, a gap G is formed between a lower surface of the blade 51 and the mask plate 25. The flow of the coating liquid 49 is guided by the front side surface 55 of the blade 51, with the result that the coating liquid 49 is pressed thereby. Thus, the coating liquid 49 is pushed into the gap G. When the coating liquid 49 passes the lower surface (pressure surface 59) of the blade 51 facing the to-be-coated surface 57, the coating liquid 49 is charged into the opening 27 of the mask plate 25. As a result, the coating liquid 49 is applied evenly onto the to-be-coated surface 57.

Operations of the vacuum pump 19, the air cylinder 23, the vacuum pump 33, the elevating unit 35, the coating liquid supply device 45, the nozzle elevating device 47, and the moving unit 53 are controlled individually by a control portion 63.

When the opening 27 of the mask plate 25 has an opening extending with a continuous length of at least 50 mm in the longitudinal direction of the blade 51, an effect of uniform coating performance by blade coating according to the invention as will be described later becomes conspicuous. In the embodiment, the opening 27 is formed into a circular shape with a diameter of about 120 mm.

In the blade coating apparatus 100 according to the embodiment, the thickness of the coating liquid layer at the time of application is at least 100 μm. When coating is performed thus with a coating thickness of at least 100 μm, the tendency for the surface property of the coating liquid layer to follow the surface of the to-be-coated surface 57 becomes lower than that in the case of thin coating. As a result, the shape of the blade 51 has great influence on the surface property of the coating liquid layer. That is, the surface property of the coating liquid layer is hardly influenced by the roughness of the to-be-coated surface 57, but chiefly depends on the pressure of the coating liquid 49 applied by the blade 51, the wicking of the coating liquid 49 due to the shape of the blade 51, etc.

When the blade coating apparatus 100 is used as a disk coating apparatus for forming at least one of recording layers in a disk-like recording medium (optical disk), a printing layer (ink accepting layer) on which, for example, an inkjet printer will print, can be formed. According to the disk coating apparatus, the printing layer can be formed with a necessary and sufficient thickness so that excellent color reproducibility can be secured when printing is performed on the printing layer. Practically when the coating liquid layer has a thickness of about 150 μm at the time of application, the coated film formed thus is about 30 μm thick due to loss in weight after drying. This ink accepting layer about 30 μm thick leads to excellent color reproducibility.

Next, a method for coating the coating liquid by use of the blade coating apparatus 100 will be described.

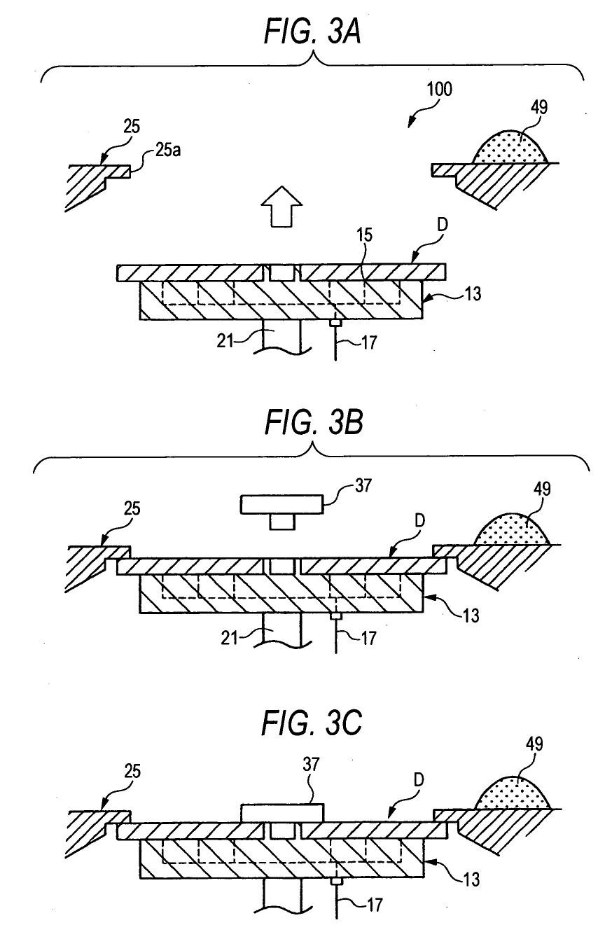

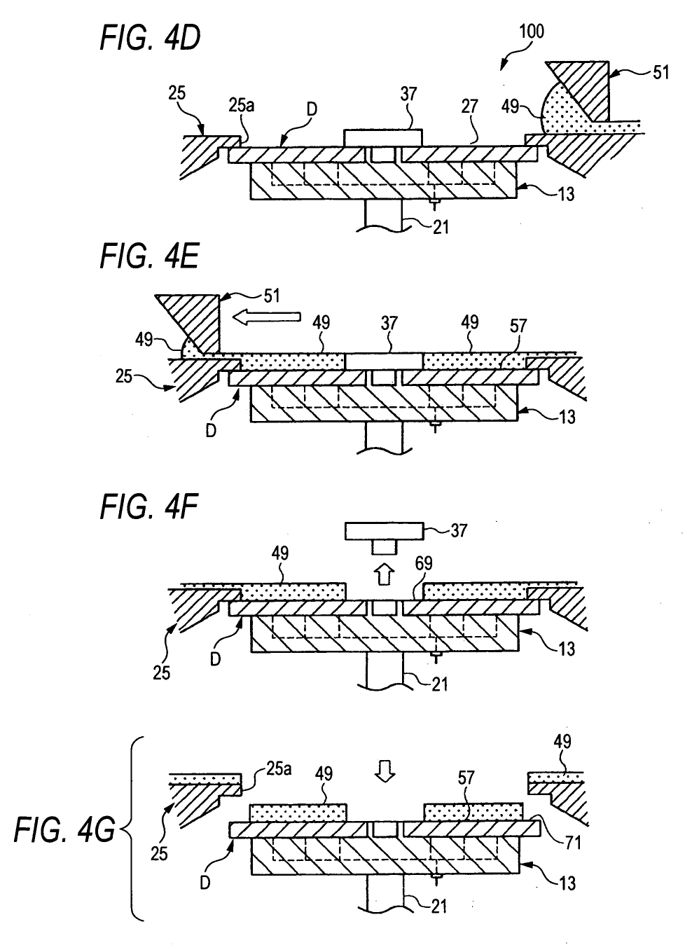

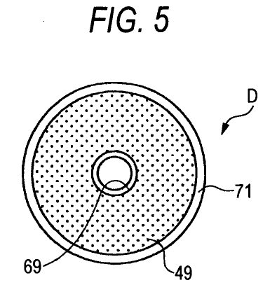

FIGS. 3A-3C are explanatory views showing the procedure of the coating method according to the invention. FIGS. 4D-4G are explanatory views showing the procedure of the coating method according to the invention. FIG. 5 is a plan view of a to-be-coated member which has been completely coated.

First, as shown in FIG. 3A, in accordance with an instruction of a control portion 63, the optical disk D is sucked on a suction stage 13 in a position where an elevating shaft 21 is moved down. As shown in FIG. 3B, an air cylinder 23 is driven to move up the suction stage 13 so that the optical disk D abuts against an opening circumferential edge 25a of the mask plate 25. Then, as shown in FIG. 3C, a mask cap sucking/releasing unit 29 is driven so that a mask cap 37 is inserted into a central hole of the optical disk D.

As shown in FIG. 4D, the blade 51 is moved leftward by a moving unit 53 so as to move a coating liquid 49 dropped on the mask plate 25 by a coating liquid supply unit 41. Then, as shown in FIG. 4E, the blade 51 together with the coating liquid 49 passes the to-be-coated surface 57 of the optical disk D so that a coating liquid layer with a predetermined thickness is formed on the to-be-coated surface 57 of the optical disk D.

Then, as shown in FIG. 4F, the mask cap sucking/releasing unit 29 is driven so that the mask cap 37 is removed from the optical disk D. In this manner, a circular step portion 69 which is not coated with the coating liquid 49 is formed in the central portion of the optical disk D. Then, as shown in FIG. 4G, the air cylinder 23 is driven to move down the suction stage 13, so that the optical disk D is moved down to leave the opening circumferential edge 25a of the mask plate 25.

A relative movement speed (i.e. operating speed of the air cylinder 23) V between the mask plate 25 and the optical disk D when they leave each other is set to be in a range of from 50 mm/sec to 200 mm/sec. Accordingly, the coating liquid 49 applied to the to-be-coated surface 57 is separated from the coating liquid 49 on the mask plate 25 by shearing. As a result, an uncoated portion 71 which is not coated with the coating liquid 49 as shown in FIG. 5 is formed due to the outer circumferential edge of the optical disk D having been covered with the mask plate 25 till then.

The relative movement speed (separation speed) V between the mask plate 25 and the optical disk D when they leave each other is set to be in the range of from 50 mm/sec to 200 mm/sec for the following reason. That is, when the relative movement speed V is not higher than 50 mm/sec, a liquid film 49A formed between the mask plate 25 and the optical disk D grows up so largely that the liquid film 49A is broken naturally. In this event, the coating liquid 49 flies around as flying drops. The flying drops adhere to the coating liquid layer. Thus, the surface property of the coating liquid layer is degraded. On the contrary, when the relative movement speed V is higher than 200 mm/sec, it may be necessary to consider durability of the apparatus or trouble caused by vibration.

When the relative movement speed V is set to be in the range of from 50 mm/sec to 200 mm/sec as described above, the liquid film 49A which may be formed between the mask plate 25 and the optical disk D can be greatly restrained from being generated. Thus, flying drops of the coating liquid 49 which may be generated when the liquid film 49A is broken, can be prevented from flying around and adhering to the coating liquid layer applied onto the optical disk D to thereby degrade the surface property of the coating liquid layer. It is also possible to avoid the influence of a too high relative movement speed V on the coating liquid layer.

Incidentally, the shape of the coating portion can be set desirably by suitably changing the shape of the opening of the mask plate 25.

Though not shown, the optical disk D coated with the coated liquid 49 as described above is removed from the suction stage 13 and transferred to a next process in which the coating liquid 49 will be dried.

Although the blade 51 is made of a stainless steel material in the aforementioned blade coating apparatus 100, the invention is not limited thereto. For example, the blade 51 may be made of a resin material or hard rubber. In addition, although the blade coating apparatus is used for coating a printing surface of an optical disk in the embodiment, a piece to be coated is not limited thereto. Any piece to be coated can be coated if it has a thick film.

According to the blade coating method in the embodiment, the relative movement speed V between the mask plate 25 and the optical disk D when they are operated to leave each other is set to be in the range of from 50 mm/sec to 200 mm/sec. Accordingly, it is possible to restrain the liquid film 49A from being generated between the mask plate 25 and the optical disk D. Thus, flying drops which may be generated when the liquid film 49A growing up in accordance with the separation operation is naturally broken, can be prevented from adhering to the optical disk D. It is therefore possible to form a coating liquid layer with a good surface property.

In the disk coating method according to the embodiment, a coating apparatus capable of coating in a large area is used to form at least one layer of a printing surface of an optical disk D. Accordingly, it is possible to form a uniform and high-quality coating liquid layer. Thus, the printing layer (ink accepting layer) on which printing will be performed, for example, by an inkjet printer can be formed to be thick enough to provide necessary and sufficient ink acceptability.

Incidentally, the blade coating apparatus according to the invention is not limited to the aforementioned embodiments but can be modified or improved suitably.

### EXAMPLES

### Example 1

Next, Examples and Comparative Examples in each of which a coating liquid was applied onto an optical disk by a blade coating apparatus having the same configuration as that in the embodiment will be described.

A coating liquid composed of materials shown in Table 1 for forming an accepting layer in the optical disk was used. This coating liquid was applied with a thickness of 100-200 μm on a surface of the optical disk. Incidentally, the viscosity of the coating liquid was measured by a B-type viscosimeter (Vismetron) under an environment of 25° C. As a result, the viscosity of the coating liquid was 500 cP.

TABLE 1

| Material | Quantity | |
|---|---|---|
| Vapor deposited silica particle | 8.0 | parts |
| Ion exchanged water | 52.5 | parts |
| Polyoxymethylene lauryl ether | 3.0 | parts |
| Aqueous solution of polyvinyl alcohol (9%) | 26.0 | parts |
| Diethylene glycol monobutyl ether | 0.5 | parts |
| Boric acid (6%) | 10.0 | parts |
| Total | 100.0 | parts |

An air cylinder was used as a mask separating means for separating a mask and an optical disk. A coating liquid was applied onto a to-be-coated surface of the optical disk while a relative movement speed V was changed suitably. Then, the existence of generation of a liquid film, and the surface property of an ink accepting layer (coating liquid layer) formed on the optical disk were evaluated in each relative movement speed by comparison.

As evaluation standards, “no liquid film generated” is evaluated as “good” (◯), “a liquid film generated” is evaluated as “acceptable” (Δ) and “existence of flying drops of coating liquid” is evaluated as “fail” (X).

The air cylinder used here was MPG-M-32-75 (cylinder diameter Φ 32 mm, stroke 75 mm, and maximum pressure 1.6 MPa) made by Scientific Materials Corp. The maximum speed was 187.5 mm/sec as an actual measurement value.

Table 2 shows results of the evaluation.

TABLE 2

| | Relative | | |
|---|---|---|---|
| | Movement | Existence of Generation of | |
| | Speed | Liquid Film, Surface | |
| | mm/sec | Property | Determination |
| Comparative | 25 | A liquid film generated, | Δ or X |
| Example | | with drops flying | |
| Example 1 | 50 | No liquid film generated | ◯ |
| Example 2 | 70 | No liquid film generated | ◯ |
| Example 3 | 90 | No liquid film generated | ◯ |

It was proved as shown in Table 2 that generation of a liquid film was confirmed when the relative movement speed V was 25 mm/sec, and drops flying around when the liquid film was broken had an influence on the surface property of the ink accepting layer (coating liquid layer). In addition, it was confirmed that generation of a liquid film was not observed when the relative movement speed V was set to be not lower than 50 mm/sec, and excellent coating could be therefore attained without any deterioration in the surface property caused by flying of drops.

This application is based on Japanese Patent application JP 2005-10531, filed Jan. 18, 2005, the entire content of which is hereby incorporated by reference, the same as if set forth at length.

What is claimed is:

1. A blade coating method comprising:
laying a mask on top of a flat substrate, the mask having an opening;
supplying a coating liquid onto the mask;
applying the coating liquid onto the mask by use of a blade moving above the mask and relatively to the mask; and
separating the mask and the flat substrate from each other, so as to form a coating liquid layer on the flat substrate in accordance with the opening of the mask; wherein:
a relative movement speed between the mask and the flat substrate when the mask and the flat substrate are operated to leave each other is set to be in a range of from 50 mm/sec to 200 mm/sec.

2. The blade coating method according to claim 1, wherein the coating liquid has a viscosity at 25° C. of 150 cP to 800 cP.

3. The blade coating method according to claim 1, wherein the coating liquid has a viscosity at 25° C. of 200 cP to 600 cP.

4. The blade coating method according to claim 1, wherein the coating liquid layer has a thickness of at least 100 μm at the time of application.

5. A disk coating method comprising:
forming at least one layer of a printing surface of a recording medium by use of a blade coating method according to claim 1.
